(19) United States
(12) Patent Application Publication
(10) Pub. No.: US 2016/0302534 A1
(43) Pub. Date: Oct. 20, 2016

(54) LOOP COMPONENTS FOR HOOK-AND-LOOP FASTENERS AND METHODS OF MAKING THE SAME

(71) Applicant: 3M INNOVATIVE PROPERTIES COMPANY, St. Paul, MN (US)

(72) Inventors: Zhiqun Zhang, Roseville, MN (US); Ryan M. Luepke, New Brighton, MN (US); Michael R. Gorman, Lake Elmo, MN (US); Shou-Lu G. Wang, Woodbury, MN (US)

(73) Assignee: 3M INNOVATIVE PROPERTIES COMPANY, St. Paul, MN (US)

(21) Appl. No.: 15/035,732

(22) PCT Filed: Nov. 10, 2014
(86) PCT No.: PCT/US14/64846

§ 371 Date: May 10, 2016

Related U.S. Application Data
(60) Provisional application No. 61/903,058, filed on Nov. 12, 2013.

(51) Int. Cl. A44B 18/00; D04H 3/14; D04H 1/54; B29C 43/24; B29C 43/46

(52) U.S. Cl. CPC A44B 18/0011; A44B 18/0069; B29C 43/24; B29C 43/46; D04H 1/54; D04H 3/14; B29L 2031/729

(57) ABSTRACT

Loop components for hook-and-loop fasteners and methods of making the same. The loop components comprise single-layer nonwoven webs having a first side, a second side opposite the first side and a thickness therebetween. The fibers of the nonwoven webs are partially fused on the first side to create a skin layer. The nonwoven webs have a basis weight ranging from 20 gsm to 50 gsm and a pressure drop index ranging from 40 to 100.

### FIELD OF INVENTION

Loop components for hook-and-loop fasteners and methods of making the same. The loop components can be used in a variety of applications, including fastening devices in personal hygiene products such as infant diapers, feminine hygiene articles, adult incontinence devices and disposable garments.

### BACKGROUND

Nonwoven webs are typically used to make loop components of hook-and-loop fasteners where textile-like properties such as softness and drapeability are desired. Such loop components are found, for example, in personal hygiene products, including infant diapers, feminine hygiene articles, adult incontinence devices and disposable garments. However, nonwoven webs have significant shortcomings. Printing is becoming increasingly desirous in such products, but the rough fibrous surface of a nonwoven web leads to poor print quality. Additionally, nonwoven webs typically exhibit poor mechanical integrity and a high degree of porosity, making them somewhat difficult to handle on a processing line. Solutions to the above problems have included laminating the nonwoven web to a thermoplastic backing. However such solutions increase the complexity and cost of manufacture.

### SUMMARY

The present disclosure describes loop components comprising skinned nonwoven webs. The loop components typically exhibit improved print quality and processing capabilities when contrasted to loop components made from unskinned nonwoven webs. Additionally, the loop components typically cost less than loop components made from nonwoven laminates. The present disclosure also describes methods of making the loop components.

In one embodiment, the invention provides a loop component of a hook-and-loop fastener, the loop component comprising: a single-layer nonwoven web having a first side, a second side opposite the first side and a thickness therebetween, the single-layer nonwoven web comprising fibers, the fibers of the single-layer nonwoven web partially fused on the first side to create a skin layer, the second side of the single-layer nonwoven web engageable with a hook component of a hook-and-loop fastener, where the single-layer nonwoven web has a basis weight ranging from 20 gsm to 50 gsm, and where the single-layer nonwoven web has a pressure drop index ranging from 40 to 100.

In another embodiment, the invention provides a method of making a loop component of a hook-and-loop fastener comprising: passing a single-layer nonwoven web through a nip created by a heated roll and a back-up roll, the single-layer nonwoven web comprising fibers and having a first side facing the heated roll, a second side facing the back-up roll and a thickness therebetween, the heated roll having a temperature above the melting point of at least some of the fibers; and partially dry fusing the fibers on the first side of the single-layer nonwoven web to create a skin layer, where the nonwoven web has a basis weight ranging from about 20 gsm to about 50 gsm, and where the nonwoven web has a pressure drop index ranging from 40 to 100.

As used herein, the terms “including,” “comprising,” or “having” and variations thereof encompass the items listed thereafter and equivalents thereof, as well as additional items. All numerical ranges are inclusive of their endpoints and non-integral values between the endpoints unless otherwise stated. Terms such “top,” “bottom,” “first side,” “second side” and the like are only used to describe elements as they relate to one another, but are in no way meant to recite specific orientations of an article or apparatus, to indicate or imply necessary or required orientations of an article or apparatus, or to specify how an article or apparatus described herein will be used, mounted, displayed, or positioned in use.

The term “machine direction” or “MD”, as used herein, refers to the direction of a running, continuous web during the manufacture of a nonwoven article.

The term “cross direction” or “CD”, as used herein, refers to the direction which is essentially normal to the machine direction.

The term “skin layer”, as used herein, refers to the surface layer in a nonwoven web where the fibers have been partially fused together. Partial fusion retains at least some of the fibrous structure of the nonwoven web while typically reducing loft and air-permeability. In contrast, complete fusion would cause the fibers in the surface layer to melt into one solid sheet, thus destroying the fibrous structure and rendering the nonwoven web air-impermeable.

The term “skinning”, as used herein, refers to the process of creating the skin layer on a nonwoven web.

The term “skinned nonwoven web” or “skinned web”, refers to a nonwoven web comprising a skin layer on one side.

The term “single-layer nonwoven web”, refers to a nonwoven web that is essentially uniform throughout. This is in contrast to multilayer nonwoven laminates with distinctly different layers (e.g., needle-punched laminates).

The above summary of the present disclosure is not intended to describe each disclosed embodiment or every implementation of the present disclosure. The description that follows more particularly exemplifies illustrative embodiments. It is to be understood, therefore, that the drawings and following description are for illustrative purposes only and should not be read in a manner that would unduly limit the scope of this disclosure.

### BRIEF DESCRIPTION OF THE DRAWINGS

FIG. 1 is a cross-sectional view of an exemplary loop component of the present disclosure; and

FIG. 2 is a schematic representation of an exemplary method for skinning the nonwoven webs used to make loop components of the present disclosure.

### DETAILED DESCRIPTION

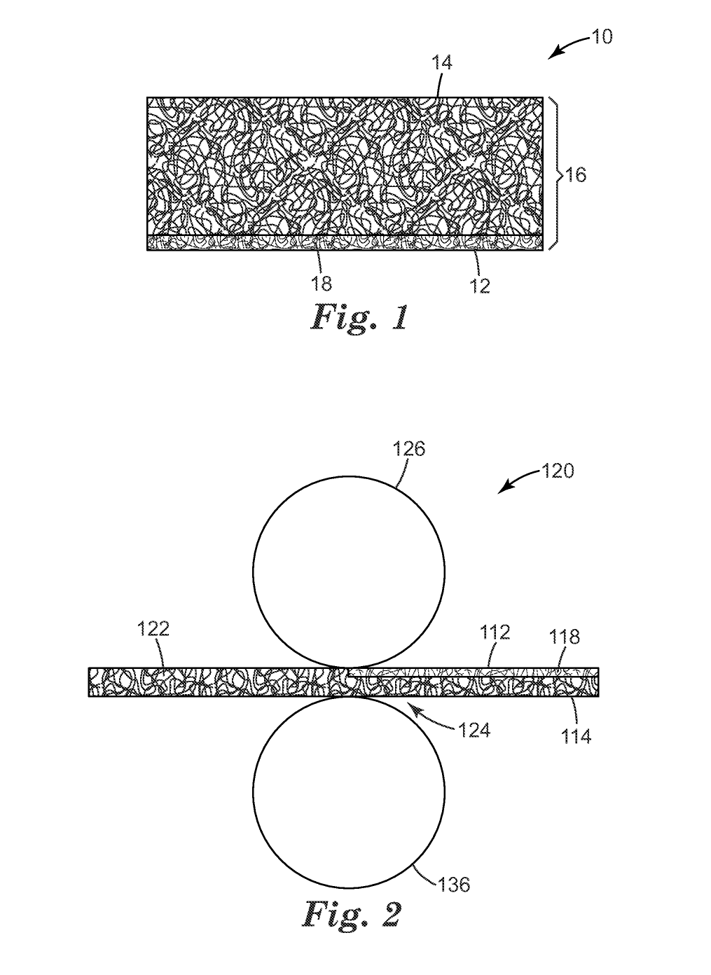

An exemplary loop component of the present disclosure is illustrated in FIG. 1. The loop component comprises a single-layer nonwoven web 10 having a first side 12, a second side 14 opposite the first side 12 and a thickness 16 therebetween. The nonwoven webs of the present disclosure have a basis weight ranging from 20 gsm to 50 gsm, more particularly from 25 gsm to 40 gsm, and even more particularly from 30 gsm to 40 gsm.

The nonwoven web 10 comprises fibers (not shown). The fibers on the first side 12 of the nonwoven web 10 are partially fused together to create a skin layer 18. Partial fusion retains at least some of the fibrous structure of the nonwoven web while typically reducing loft and air-permeability. In contrast, complete fusion would cause the fibers in the surface layer to melt into a solid sheet, thus destroying the fibrous structure and rendering the nonwoven web air-impermeable. Air-permeability of the nonwoven web is correlated to the pressure drop index as defined in the Examples section. The nonwoven webs of the present disclosure have a pressure drop index ranging from 40 to 100, more particularly from 40 to 80.

The skin layer 18 forms a relatively small percentage of the nonwoven web 10. Typically, the skin layer 18 forms 5% to 20%, more particularly 5% to 15%, and even more particularly 5% to 10% of the thickness 16 of the nonwoven web 10. The ability to create such a thin skin layer means the second side 14 (or unskinned side) of the nonwoven web 10 maintains sufficient loft to engage with the hook component of a hook-and-loop fastener.

Although the nonwoven web 10 in FIG. 1 is not embossed, it should be understood by one skilled in the art that an embossing pattern may be applied to the second side 14 of the nonwoven web 10. An embossing pattern can enhance the mechanical integrity of the nonwoven web, impart a 3D visual effect to the web, and enhance the texture of the unskinned side of the nonwoven web. The embossing pattern is not particularly limiting and will be dictated to some extent by the article into which the loop component is incorporated.

Loop components comprising nonwoven web 10 exhibit a number of advantages. For example, the skin layer improves the mechanical integrity of the web so that it can more easily withstand the tensions exerted in a manufacturing line. The nonwoven webs of the present disclosure typically have a tensile strength at maximum load ranging from 20N to 80N, more particularly from 25N to 60N, in the machine direction, and from 6N to 22N, more particularly from 8N to 20N, in the cross direction. The nonwoven webs of the present disclosure also typically have a tensile strength at 5% stretch from 4N to 20N, more particularly from 6N to 20N, in the machine direction, and from 2N to 10N, more particularly from 3N to 8N, in the cross direction.

The skin layer also reduces the air-permeability of the nonwoven web which can also lead to improved processing capabilities. A common way to maintain a web on a manufacturing line is by application of a vacuum. However, nonwoven webs are typically too porous to respond to the suction created by a vacuum. By skinning one side of a nonwoven web, the air-permeability decreases such that the web is more easily managed with the application of a vacuum on a processing line.

Although the skin layer reduces the air-permeability of the nonwoven web, it does not eliminate breathability. Breathability is particularly important for applications in personal hygiene products, such as diapers and feminine hygiene articles, where vapor permeability enhances user comfort.

The skin layer also enhances the printability of the nonwoven web. Although the skin layer retains at least some of the fibrous structure of the nonwoven web, the skin layer also exhibits reduced loft and roughness when contrasted with the nonwoven web before skinning. Such reduced loft and roughness provide for better print quality. In some embodiments of the present disclosure, a colored ink used to create a printed pattern on a skinned nonwoven web has a chroma value, as measured from the skin layer of the nonwoven web, from 10% to 120% greater that the chroma value of the same ink printed on the same nonwoven web without the skin layer.

The composition of the nonwoven webs is not particularly limiting. Nonlimiting examples of suitable nonwoven webs include spunbond webs, carded webs, dry laid webs, meltblown webs and combinations thereof. The webs can be elastic or inelastic. The nonwoven webs have a basis weight ranging from 20 gsm to 50 gsm, more particularly from 25 gsm to 40 gsm, and even more particularly from 30 gsm to 40 gsm. The fibers making up the nonwoven webs typically have a fiber size ranging from 1.5 denier to 8 denier, more particularly from 1.8 denier to 4 denier.

Spunbond nonwoven webs are made by extruding a molten thermoplastic, as filaments, from a series of fine die orifices in a spinneret. The diameter of the extruded filaments is rapidly reduced under tension by, for example, non-eductive or eductive fluid-drawing or other known spunbond mechanisms, such as described in U.S. Pat. No. 4,340,563 (Appel et al.); U.S. Pat. No. 3,692,618 (Dorschner et al.); U.S. Pat. No. 3,338,992 and U.S. Pat. No. 3,341,394 (Kinney); U.S. Pat. No. 3,276,944 (Levy); U.S. Pat. No. 3,502,538 (Peterson); U.S. Pat. No. 3,502,763 (Hartman) and U.S. Pat. No. 3,542,615 (Dobo et al.). The spunbond web is preferably bonded (e.g., point or continuous bonded).

The nonwoven web may also be made from carded webs. Carded webs are made from separated staple fibers that are sent through a combing or carding unit which separates and aligns the staple fibers in the machine direction so as to form a generally machine direction-oriented fibrous nonwoven web. However, randomizers can be used to reduce this machine direction orientation.

Once the carded web has been formed, it is typically bonded by one or more of several bonding methods to give it suitable tensile properties. One bonding method is powder bonding wherein a powdered adhesive is distributed through the web and then activated, usually by heating the web and adhesive with hot air. Another bonding method is pattern bonding wherein heated calender rolls or ultrasonic bonding equipment are used to bond the fibers together, usually in a localized bond pattern though the web can be bonded across its entire surface if so desired. Generally, the more the fibers of a web are bonded together, the greater the nonwoven web tensile properties.

Airlaying is another process by which fibrous nonwoven webs can be made. In the airlaying process, bundles of small fibers usually having lengths ranging between 6 to 19 millimeters are separated and entrained in an air supply and then deposited onto a forming screen, often with the assistance of a vacuum supply. The randomly deposited fibers are then bonded to one another using, for example, hot air or a spray adhesive.

Meltblown nonwoven webs may be formed by extrusion of thermoplastic polymers from multiple die orifices, where the polymer melt streams are immediately attenuated by hot high velocity air or steam along two faces of the die immediately at the location where the polymer exits from the die orifices. The resulting fibers are entangled into a coherent web in the resulting turbulent airstream prior to collection on a collecting surface. Meltblown webs may be further bonded such as by through air bonding, heat or ultrasonic bonding.

Nonwoven webs may be made of synthetic fibers (e.g., thermoplastic fibers) or a combination of synthetic fibers and natural fibers (e.g., wood, cotton or wool). Exemplary materials for forming thermoplastic fibers include polyolefins, polyamides, polyesters, copolymers containing acrylic monomers, and blends and copolymers thereof. Suitable polyolefins include polyethylene, e.g., linear low density polyethylene, high density polyethylene, low density polyethylene and medium density polyethylene; polypropylene, e.g., isotactic polypropylene, syndiotactic polypropylene, blends thereof and blends of isotactic polypropylene and atactic polypropylene; and polybutylene, e.g., poly(1-butene) and poly(2-butene); polypentene, e.g., poly-4-methylpentene-1 and poly(2-pentene); as well as blends and copolymers thereof. Suitable polyamides include nylon 6, nylon 6/6, nylon 10, nylon 4/6, nylon 10/10, nylon 12, nylon 6/12, nylon 12/12, and hydrophilic polyamide copolymers such as copolymers of caprolactam and an alkylene oxide, e.g., ethylene oxide, and copolymers of hexamethylene adipamide and an alkylene oxide, as well as blends and copolymers thereof. Suitable polyesters include polyethylene terephthalate, polybutylene terephthalate, polycyclohexylenedimethylene terephthalate, and blends and copolymers thereof. Acrylic copolymers include ethylene acrylic acid, ethylene methacrylic acid, ethylene methylacrylate, ethylene ethylacrylate, ethylene butylacrylate and blends thereof. Particularly suitable polymers are polyolefins, including polyethylene, e.g., linear low density polyethylene, low density polyethylene, medium density polyethylene, high density polyethylene and blends thereof; polypropylene; polybutylene; and copolymers as well as blends thereof.

The nonwoven webs may be made from a single component fiber, a bicomponent fiber, or combinations thereof. The term “bicomponent”, as used herein, means comprising two or more separate components, each of which extends longitudinally along the fiber through a cross-sectional area of the fiber. For example, in a fiber comprising two components, the first component may be disposed more in the center of the fiber, with the second component wrapped partially or completely around the first component. In the latter case, the first component becomes a core and the second component becomes a sheath. More than two different polymeric materials may be included in bicomponent fibers, e.g., as separate layers.

Bicomponent fibers may be formed from a wide variety of fiber-forming materials. Representative combinations of polymeric materials for the components of a fiber include: polyester (e.g., polyethylene terephthalate) and polypropylene; polyethylene and polypropylene; polyester (e.g, polyethylene terephthalate) and linear polyamides such as nylon 6; polybutylene and polypropylene; and polystyrene and polypropylene. Also, different materials may be blended to serve as one component of a bicomponent fiber.

The polymeric components in a two-component bicomponent fiber of this disclosure may be included in approximately the same volume amounts, or in amounts ranging between about 30 and 70 volume percent for each of the components. However, amounts outside this range are contemplated as well. In one embodiment, a bicomponent fiber comprises 50% polypropylene core and 50% polyethylene sheath. In another embodiment, a bicomponent fiber comprises 50% polyester core and 50% polyethylene sheath.

The nonwoven webs of the present disclosure may be made of a single fiber or blends of two or more fibers having, for example, different compositions, diameters and/or lengths. The nonwoven webs may also include additional ingredients, such as dyes, pigments, binders, bleaching agents, thickening agents, softening agents, detergents, surface active agents, and combinations thereof.

The nonwoven webs of the present disclosure form loop components that reversibly attached and detach from a hook component in a hook-and-loop fastener. The hook component typically comprises a base layer, stems extending from the base layer, and loop engageable portions at the end of the stems opposite the base layer. The loop engageable portions may have the shape of a crook, the letter “T”, a flat disc, a mushroom head, or any other shape allowing for engagement with a corresponding nonwoven web. Hook components can be manufactured from a wide range of materials, including nylon, polyester, polyolefins or any combination of these. Exemplary hook components are disclosed, for example in U.S. Pat. No. 4,894,060, U.S. Pat. No. 5,077,870, U.S. Pat. No. 5,679,302 and WO 2012/112768 and sold, for example, by 3M Company in St. Paul, Minn., USA.

FIG. 2 illustrates an exemplary method for “skinning” the webs used to make the loop components of the present disclosure. A skinning station 120 comprises a heated roll 126, a back-up roll 136, and a nip 124 therebetween. A nonwoven web 122 having a first side 112 and a second side opposite the first side 114 is passed between the nip 124. The first side 112 of the nonwoven web 122 faces the heated roll 126, and the second side 114 of the nonwoven web 122 faces the back-up roll. The fibers on the first side 112 of the nonwoven web 122 are partially fused to create a skin layer 118, whereas the fibers on the second side 114 of the nonwoven web 112 remain essentially unchanged. Preferably, a dry fusion process is used. The term “dry fusion”, as used herein, means that that the nonwoven web 122 is relatively dry and that fusion results from heat transferred directly from the heated roll 126 to the fibers. This is in contrast to a wet fusion process where a wetting agent may be applied to the nonwoven web to help regulate the temperature of the fusion process.

The heated roll 126 is maintained at a temperature above the melting point of at least some of the nonwoven web fibers. For example, the heated roll 126 may be maintained at 149° C. to 177° C. (300° F. to 350° F.) for a nonwoven web made from polypropylene fibers. The heated roll 126 is typically made of nickel-hardened steel. However, any material that remains hard at the required operating temperature may be used (e.g., a chrome roll with a suitable release coating). Suitable means for heating the heated roll 126 include interior circulating hot oil, resistance heaters, high pressure steam or other suitable heating fluid passed through the core of the heated roll 126. The heated roll typically has a smooth surface. However, the surface of the heated roll can have small surface structures (e.g., dimples or raised raised ridges) not to exceed 100 μm.

The back-up roll 136 is typically maintained at room temperature so that the side of the nonwoven web facing the back-up roll 136 remains relatively unchanged. The back-up roll 136 may be maintained at lower temperatures. However, this is less favorable from a processing standpoint. The back-up roll 136 should be resilient to provide a more uniform distribution of pressure across the nonwoven web 122 as it passes through the nip 124 of the skinning station 120. Exemplary back-up rolls include rubber, silicone coated rolls and cloth wrapped rolls. Alternatively, the back-up roll 136 may be replaced by an air knife that maintains the nonwoven web against the heated roll 126 as it passes through the skinning station 120.

The degree of fusion on the first side 112 of the nonwoven web 122 is dependent upon a number of inter-related processing parameters that include line speed, temperature of the heating roll, composition of the nonwoven web and nip pressure. For example, as the line speed increases, the amount of time the nonwoven web 122 is in contact with the heating roll 126 decreases. In order to compensate, the heating roll 126 temperature and/or the nip pressure may be increased. The processing parameters are carefully selected so that the skinned nonwoven web has a pressure index ranging from 40 to 100, more particularly from 40 to 80. Preferably, the skin layer of the skinned nonwoven web is from 5% to 20%, more particularly from 5% to 15%, even more particularly from 5% to 10%, of the thickness 16 of the nonwoven web.

Typical line speeds range from 10 m/min to about 200 m/min, more particularly from 10 m/min to 50 m/min. However, this parameter is limited only by the equipment and may lie outside this range. Typical nip pressures range from 0N to 500N, more particularly 100N to 500N.

In some embodiments, the nonwoven web 122 may comprise multiple fibers with different melting points. In such instances, the temperature of the heating roll 126 may be set above the melting point of some fibers but below the melting point of others. Thus, in addition to varying the process parameters, the degree of fusion can be controlled by making the nonwoven web out of a blend of fibers.

The nonwoven web 112 is typically skinned by a single pass through the skinning station 120. However, it is also contemplated that a skinned nonwoven web could be passed through the skinning station 120 multiple times. For example, in one embodiment, a nonwoven web is passed through the skinning station twice to create the desired skin layer.

The nonwoven web 122 includes any of the webs described above. The nonwoven web 122 is easier to handle if the fibers are prebonded prior to the skinning process (e.g., point bonded or continuous bonded). However, this is not necessary. Similarly, the nonwoven web may also be embossed before or after the skinning station to impart additional integrity to the web, enhance the texture and/or improve the aesthetic appeal of the finished product. Preferably, the nonwoven web is embossed prior to skinning. In some embodiments, the fibers of the nonwoven web have a bond area from 20% to 40% prior to skinning.

If printing is desired, a printer may be located down line of the skinning station to apply ink to the first side 112 (i.e., skinned side) of the nonwoven web 122. Alternatively, the printing can be done off-line in a separate process. Both pigments and inks may be applied to the skinned side. Printing methods include screen-printing, laser printing, inkjet printing, and flexography.

A loop component comprising the skinned nonwoven web is combined with a hook component to form a hook-and-loop fastener. The skin layer of the nonwoven web enhances the mechanical integrity, the processability, and the print quality of the nonwoven web but is thin enough to maintain the loft in the unskinned portion of the nonwoven web required for hook engagement. Some fasteners comprising loop components of the present disclosure have a shear value from 20N to 60N, more particularly from 25N to 50N. Same or additional fasteners comprising loop components of the present disclosure have a peel value from 1N to 4N, more particularly from 2N to 4N.

The loop components of the present disclosure may be used in any of the variety of applications where hook-and-loop fasteners may be found. In the personal hygiene industry, nonwoven loop components (printed or not) are typically used as landing zones (or hook engageable backsheets) on infant and adult incontinence devices. They may also be used to fasten a feminine hygiene article to a garment, either by applying the loop component to the underside of the article and the hook component to the side of the garment facing the article, or reversing the positions of the hook and loop components. Although the loop components have been described particularly in reference to personal hygiene products, it should be understood that they may be incorporated into hook-and-loop fasteners in other product industries as well.

### SOME EMBODIMENTS OF THE DISCLOSURE

In a first embodiment, the present disclosure provides a loop component of a hook-and-loop fastener, the loop component comprising: a single-layer nonwoven web having a first side, a second side opposite the first side and a thickness therebetween, the single-layer nonwoven web comprising fibers, the fibers of the single-layer nonwoven web partially fused on the first side to create a skin layer, the second side of the single-layer nonwoven web engageable with a hook component of a hook-and-loop fastener, where the single-layer nonwoven web has a basis weight ranging from 20 gsm to 50 gsm, and where the single-layer nonwoven web has a pressure drop index ranging from 40 to 100.

In a second embodiment, the present disclosure provides the loop component of the first embodiment, wherein the skin layer forms 5% to 20% of the thickness of the single-layer nonwoven web.

In a third embodiment, the present disclosure provides the loop component of the first or second embodiment, wherein the single-layer nonwoven web has a tensile strength at maximum load from 20N to 80N in the machine direction.

In a fourth embodiment, the present disclosure provides the loop component of any one of the first to third embodiments, wherein the single-layer nonwoven web has a tensile strength at maximum load from 6N to 22N in the cross direction.

In a fifth embodiment, the present disclosure provides the loop component of any one of the first to fourth embodiments, wherein the single-layer nonwoven web has a tensile strength at 5% stretch from 4N to 20N in the machine direction.

In a sixth embodiment, the present disclosure provides the loop component of any one of the first to fifth embodiments, wherein the single-layer nonwoven web has a tensile strength at 5% stretch from 2N to 10N in the cross direction.

In a seventh embodiment, the present disclosure provides the loop component of any one of the first to sixth embodiments, wherein the hook-and-loop fastener has a shear value from 20N to 60N.

In an eighth embodiment, the present disclosure provides the loop component of any one of the first to seventh embodiments, wherein the hook-and-loop fastener has a peel value from 1N to 4N.

In a ninth embodiment, the present disclosure provides the loop component of any one of the first to eighth embodiments, further comprising a printed pattern on the skin layer.

In a tenth embodiment, the present disclosure provides the loop component of the ninth embodiment, wherein a colored ink used to create the printed pattern has a chroma value, as measured from the first side of the single-layer nonwoven web, from 10% to 120% greater than the chroma value of the same ink printed on the first side of the single-layer nonwoven web without the skin layer.

In an eleventh embodiment, the present disclosure provides the loop component of any one of the first to tenth embodiments, wherein the fibers range from 1.5 denier to 8 denier in size.

In a twelfth embodiment, the present disclosure provides the loop component of any one of the first to eleventh embodiments, wherein at least some of the fibers are bicomponent fibers.

In a thirteenth embodiment, the present disclosure provides the loop component of any one of the first to twelfth embodiments, wherein the bicomponent fibers comprise a polypropylene core and a polyethylene sheath.

In a fourteenth embodiment, the present disclosure provides the loop component of any one of the first to twelfth embodiments, wherein the bicomponent fibers comprise a polyester core and a polyethylene sheath.

In a fifteenth embodiment, the present disclosure provides the loop component of any one of the first to twelfth embodiments, wherein the single-layer nonwoven web comprises polypropylene fibers.

In a sixteenth embodiment, the present disclosure provides the loop component of any one of the first to fifteenth embodiments, wherein the single-layer nonwoven web has a basis weight ranging from 25 to 40 gsm.

In a seventeenth embodiment, the present disclosure provides the loop component of any one of the first to sixteenth embodiments, further comprising an embossing pattern in the second side of the nonwoven web.

In an eighteenth embodiment, the present disclosure provides a personal hygiene product comprising the loop component of any one of the first to seventeenth embodiments.

In a nineteenth embodiment, the present disclosure provides a method of making a loop component of a hook-and-loop fastener comprising: passing a single-layer nonwoven web through a nip created by a heated roll and a back-up roll, the single-layer nonwoven web comprising fibers and having a first side facing the heated roll, a second side facing the back-up roll and a thickness therebetween, the heated roll having a temperature above the melting point of at least some of the fibers; and partially dry fusing the fibers on the first side of the single-layer nonwoven web to create a skin layer, where the nonwoven web has a basis weight ranging from 20 gsm to 50 gsm, and where the nonwoven web has a pressure drop index ranging from 40 to 100.

In a twentieth embodiment, the present disclosure provides the method of the nineteenth embodiment, wherein the skin layer forms 5% to 20% of the thickness of the single-layer nonwoven web.

In a twenty-first embodiment, the present disclosure provides the method of the nineteenth or twentieth embodiment, wherein the heated roll is a steel roll with a nickel-hardened steel surface.

In a twenty-second embodiment, the present disclosure provides the method of any one of the nineteenth to twenty-first embodiments, wherein the back-up roll comprises a resilient surface made of rubber.

In a twenty-third embodiment, the present disclosure provides the method of any one of the nineteenth to twenty-second embodiments, wherein the fibers of the single-layer nonwoven web are prebonded.

In a twenty-fourth embodiment, the present disclosure provides the method of any one of the nineteenth to twenty-third embodiments, wherein the single-layer nonwoven web is passed through the nip at a rate of about 10 m/min to about 200 m/min.

In a twenty-fifth embodiment, the present disclosure provides the method of any one of the nineteenth to twenty-fourth embodiments, wherein the single-layer nonwoven web is subjected to a nip pressure from 0N to 500N.

In a twenty-sixth embodiment, the present disclosure provides the method of any one of the nineteenth to twenty-fifth embodiments, wherein the single-layer nonwoven web is embossed prior to partially dry fusing the fibers.

### Examples

The following examples are presented to illustrate some of the advantages of the loop components of the present disclosure and are not intended in any way to otherwise limit the scope of the invention.

### Materials

ES FIBERVISIONS™ FIBER ESC021AF (Fiber 1)—a 50% polyethylene sheath/50% polypropylene core bicomponent fiber (2 denier) from FiberVisions®, Inc. in Covington, Ga., USA.
ES FIBERVISIONS™ FIBER ESC 233CL1 (Fiber 2)—a 50% polyethylene sheath/50% polypropylene core bicomponent fiber (3 denier) from FiberVisions®, Inc. in Covington, Ga., USA.
ES FIBERVISIONS™ FIBER ETC233 (Fiber 3)—a 50% polyethylene sheath/50% polyester core bicomponent fiber (3 denier) from FiberVisions®, Inc. in Covington, Ga., USA.
FiberVisions® HY-Comfort 1.9 Denier T196 Fiber (Fiber 4)—a 100% polypropylene fiber from FiberVisions®, Inc. in Covington, Ga., USA.
FiberVisions® HY-Comfort 4 Denier T196 Fiber (Fiber 5)—a 100% polypropylene fiber from FiberVisions®, Inc. in Covington, Ga., USA.
Fiber 6—a 30% polyethylene sheath/70% polypropylene core bicomponent fiber (3 denier).

### Test Methods

### Shear

A sample of nonwoven loop component measuring 76 mm (CD)×30 mm (MD) was laminated to filament tape (Filament Tape 898 available from 3M™ Company in St. Paul, Minn., USA). A hook component (300 μm cap, 1750 pins/2.54 cm²) measuring 12.7 mm (CD)×25.4 mm (MD) (3M™ CHK04933 hook available from 3M™ Company in St. Paul, Minn., USA) was applied to the side of the loop component opposite the taped side such that the loop component completely covered the hook component. The hook component was secured to the loop component by 10 passes with a 5 kg roller. A leader extending from one end of the hook component was attached to the upper jaw of an Instron® Tensile Tester, Model 1122 (available from Instron® in Norwood, Mass., USA) while the loop component was attached to the lower jaw. The materials were oriented so that shear was measured in the CD for both the hook and loop components.

The hook component was pulled at a rate of 305 mm/min until completely disengaged from the loop component. The tensile strength at maximum load was recorded for ten samples of nonwoven loop component, and the average was reported.

### Peel

A sample of nonwoven loop component measuring 125 mm (CD)×50 mm (MD) was attached to a steel plate with double-sided tape. A hook component measuring 19 mm (CD)×25.4 mm (MD) was laminated to a fastening tape (Scotch® Filament Tape 898 available from 3M™ Company in St. Paul, Minn., USA). The hook component was gently applied to the loop component so that the loop component completely covered the hook component. The hook component was secured to the loop component by two passes with a 2 kilogram roller. A paper leader extending from one of the 25.4 cm ends of the hook component was attached to the upper jaw of an Instron® Tensile Tester, Model 1122, while the loop component was attached to the lower jaw. The materials were oriented so that peel was measured in the CD for both the hook and loop components.

The hook component was peeled from the loop component at an angle of 135° and a rate of 305 mm/min. The tensile strength at maximum load was recorded for ten samples of nonwoven loop component, and the average was reported.

### Tensile

Tape leaders were attached to the shorter ends of a sample nonwoven loop component measuring 25 mm×100 mm. One tape leader was attached to the upper jaw of an Instron® Tensile Tester, Model 1122, while the other tape leader was attached to the lower jaw. The tape leaders were pulled at a rate of 254 mm/min. The tensile strength at maximum load and the tensile strength at 5% stretch were recorded for ten samples of nonwoven loop component, and the average was reported.

### Chroma

A SP64 X-Rite Spectrophotometer (available from X-Rite in Grand Rapids, Mich., USA) was used to measure the chroma of liquid ink applied to the skin side of a sample nonwoven web under the following conditions: D65 lighting; 10° observation angle; and an 8 mm aperture. A hand ink roller measuring 16 cm in diameter was used to apply a magenta liquid ink (NT23 BR magenta from Colorcon, Inc. in Harleysville, Pa., USA). The L, a, b values were measured, and chroma was calculated according to the following equation:

chroma=\sqrt{a²+b²}

Chroma was measured from both sides of the loop component—the skinned side (i.e., printed side) and the side opposite the skinned side (i.e., non-printed side). The average chroma for three samples was reported.

### Pressure Drop Index

A TSI® Automated Filter Tester 8130 available from TSI® Inc. in Shoreview, Minn., USA was used to measure the pressure drop across a sample nonwoven web under the following conditions: atomizer pressure of 2 bars; chuck pressure of 4 bars; and dilution (air) pressure of 50 SLPM (standard liters per minute). The nonwoven web was placed in the instrument chuck. The pressure drop across the web was measured in mm H₂O and then converted to dyne/cm². The pressure drop index (in denier) was calculated according to the following equation, with the basis weight measured in dyne/cm². The average pressure drop index for five samples was reported.

$$Pressure Drop Index = \frac{( Pressure Drop ) \times ( Fiber Denier )}{Nonwoven Basis Weight}$$

### Coefficient of Friction

The coefficient of friction test was based on ASTM D1894. A sample nonwoven web was fastened to a 200 g rubber sled measuring 50 mm×75 mm such that the skin layer in the Examples (or the less lofty surface in the Comparatives) was exposed. An Instron® Tensile Tester, Model 1122, was used to pull the rubber sled to which the nonwoven web was attached across a substrate fastened to a stationery bed. Both a non-woven loop sample (lofty side of the Examples and Comparatives) and 500 grit sandpaper (Wetordry™ Tri-M-ite™ available from 3M™ Company in St. Paul, Minn., USA) were used as the substrate. The sled was pulled at a rate of 150 mm/min, and the total draw length was 150 mm. The force required to pull the sled 125 mm across the test bed was measured as the dynamic coefficient of friction. The average value for three samples of nonwoven web was reported.

### Thickness

The thickness of a nonwoven web and the skin layer were measured using a Keyence VHX-600 Microscope (available from Keyence Corp. in Itasca, Ill. USA) at ×100 magnification.

### Examples E1-E10

The fibers provided in Table 1 were carded to produce nonwoven webs transported on a conveyor belt. The fiber blends in Examples E5 and E6 were hand-mixed prior to carding.

The nonwoven webs were passed through a pattern bonding nip to prebond the fibers. The bond area of the fibers was 30%. Subsequently, the nonwoven web was skinned on one side by passing the prebonded web through a nip formed from a rubber roll and a metal roll (nickel-hardened steel). All samples were passed once through the nip, except for sample E-10 which was passed through the nip twice (i.e., skinned twice). The metal roll was maintained at 160° C., and the rubber roll was maintained at 22° C. The conveyor speed was 50 m/min, and the rubber/metal nip pressure was 100 N.

TABLE 1
Examples E1-E8

| | | Basis Weight |
|---|---|---|
| Sample | Fiber | (gsm) |
| E-1 | Fiber 1 | 35 |
| E-2 | Fiber 2 | 35 |
| E-3 | Fiber 3 | 35 |
| E-4 | Fiber 4 | 35 |
| E-5 | 50% Fiber 2/ | 40 |
| | 50% Fiber 3 | |
| E-6 | 50% Fiber 2/ | 40 |
| | 50% Fiber 5 | |
| E-7 | Fiber 6 | 40 |
| E-8 | Fiber 1 | 25 |
| E-9 | Fiber 4 | 40 |
| E-10 | Fiber 4 | 35 |

### Comparative Examples C1-C8

Comparative Examples C1-C8 were prepared as described above for Examples E1-E8, except that the nonwoven webs C1-C8 were not skinned with the rubber/metal nip. The results are provided in Table 2.

TABLE 2
Comparative Examples C1-C8

| | | Basis Weight |
|---|---|---|
| Sample | Fiber | (gsm) |
| C-1 | Fiber 1 | 35 |
| C-2 | Fiber 2 | 35 |
| C-3 | Fiber 3 | 35 |
| C-4 | Fiber 4 | 35 |
| C-5 | 50% Fiber 2/ | 40 |
| | 50% Fiber 3 | |
| C-6 | 50% Fiber 2/ | 40 |
| | 50% Fiber 5 | |
| C-7 | Fiber 6 | 40 |
| C-8 | Fiber 1 | 25 |

### Results

Test results are shown in Tables 3 through Table 5.

TABLE 3
Shear, Peel and Tensile Strength Values

| | | | Tensile (N) | | | |
|---|---|---|---|---|---|---|
| | | | MD | | CD | |
| | Shear | Peel | Max | 5% | Max | 5% |
| Sample | (N) | (N) | Load | Stretch | Load | Stretch |
| E-1 | 48 | 3.5 | 59 | 14.5 | 16.9 | 6.8 |
| E-2 | 32 | 2.5 | 32 | 11.9 | 11.5 | 3.6 |
| E-3 | 26 | 2.6 | 36 | 11.9 | 13.9 | 4.9 |
| E-4 | 36 | 2.4 | 28 | 11.2 | 11.2 | 4.4 |
| E-5 | 37 | 3.2 | 38 | 10.3 | 10.0 | 5.5 |
| E-6 | 27 | 3.8 | 30 | 9.1 | 14.0 | 4.9 |
| E-7 | 37 | 1.9 | 58 | 18.0 | 14.5 | 6.5 |
| E-8 | 36 | 1.5 | 38 | 6.0 | 11.0 | 3.0 |
| C-1 | 46 | 4.3 | 49 | 8.1 | 10.6 | 3.0 |
| C-2 | 33 | 3.7 | 25 | 9.1 | 10.2 | 2.7 |
| C-3 | 28 | 2.6 | 32 | 8.6 | 10.4 | 3.5 |
| C-4 | 37 | 2.3 | 26 | 6.4 | 7.8 | 2.6 |
| C-5 | 42 | 5.2 | 35 | 4.0 | 6.1 | 2.6 |
| C-6 | 31 | 4.2 | 27 | 3.6 | 10.7 | 1.9 |
| C-7 | 37 | 1.7 | 51 | 10.3 | 10.6 | 3.6 |
| C-8 | 42 | 2.5 | 33 | 5.3 | 7.6 | 1.2 |

TABLE 4
Skin Thickness and Pressure Drop Index Values

| | | Skin Thickness | Pressure Drop |
|---|---|---|---|
| | Skin Thickness | (% non-woven | Index |
| Sample | (microns) | thickness) | (denier) |
| E-1 | 42 | 9% | 49 |
| E-2 | 46 | 9% | 40 |
| E-3 | 47 | 9% | 42 |
| E-4 | 41 | 11% | 47 |
| E-5 | 46 | 8% | 45 |
| E-6 | 47 | 8% | 44 |
| E-7 | 45 | 8% | 57 |
| E-8 | 41 | 15% | 55 |
| E-9 | 42 | 10% | 72 |
| E-10 | 43 | 12% | 89 |

TABLE 5
Coefficient of Friction Values

| | COF | COF |
|---|---|---|
| Sample | (loop substrate) | (sandpaper substrate) |
| E-1 | 0.27 | 0.87 |
| E-2 | 0.4 | 0.76 |
| E-3 | 0.31 | 1.26 |
| E-4 | 0.59 | 0.84 |
| C-1 | 0.37 | 1.22 |
| C-2 | 0.55 | 0.87 |
| C-3 | 0.37 | 1.59 |
| C-4 | 0.72 | 1.10 |

Examples E-1, E-2 and E-4 and Comparatives C-1, C-2 and C-4 were also tested for color saturation (chroma). Results are shown in Table 6.

TABLE 6
Color Saturation

| | Chroma | Chroma |
|---|---|---|
| Sample | (non-printed side) | (printed side) |
| E-1 | 19.6 | 33.7 |
| E-2 | 23.3 | 32.7 |
| E-4 | 28.1 | 42.1 |
| C-1 | 11.9 | 16.8 |
| C-2 | 19.7 | 29.1 |
| C-4 | 15.8 | 23.1 |

The embodiments described above and illustrated in the figures are presented by way of example only and are not intended as a limitation upon the concepts and principles of the present invention.

Thus, the invention provides, among other things, loop components for hook-and-loop fasteners and methods of making the same. Various features and advantages of the invention are set forth in the following claims.

What is claimed is:

1. A loop component of a hook-and-loop fastener, the loop component comprising:
a single-layer nonwoven web having a first side, a second side opposite the first side and a thickness therebetween, the single-layer nonwoven web comprising fibers, the fibers of the single-layer nonwoven web partially fused on the first side to create a skin layer, the second side of the single-layer nonwoven web engageable with a hook component of a hook-and-loop fastener,
where the single-layer nonwoven web has a basis weight ranging from 20 gsm to 50 gsm, and
where the single-layer nonwoven web has a pressure drop index ranging from 40 to 100.

2. The loop component of claim 1, wherein the skin layer forms 5% to 20% of the thickness of the single-layer nonwoven web.

3. The loop component web of claim 1, wherein the single-layer nonwoven web has a tensile strength at maximum load from 20N to 80N in the machine direction.

4. The loop component of claim 3, wherein the single-layer nonwoven web has a tensile strength at maximum load from 6N to 22N in the cross direction.

5. The loop component of claim 1, wherein the single-layer nonwoven web has a tensile strength at 5% stretch from 4N to 20N in the machine direction.

6. The loop component of claim 5, wherein the single-layer nonwoven web has a tensile strength at 5% stretch from 2N to 10N in the cross direction.

7. The loop component of claim 1, wherein the hook-and-loop fastener has a shear value from 20N to 60N.

8. (canceled)

9. The loop component of claim 1, further comprising a printed pattern on the skin layer.

10. The loop component of claim 9, wherein a colored ink used to create the printed pattern has a chroma value, as measured from the first side of the single-layer nonwoven web, from 10% to 120% greater than the chroma value of the same ink printed on the first side of the single-layer nonwoven web without the skin layer.

11-15. (canceled)

16. The loop component of claim 1, wherein the single-layer nonwoven web has a basis weight ranging from 25 to 40 gsm.

17. The loop component of claim 1, further comprising an embossing pattern in the second side of the nonwoven web.

18. personal hygiene product comprising the loop component of claim 1.

19. A method of making a loop component of a hook-and-loop fastener comprising:
passing a single-layer nonwoven web through a nip created by a heated roll and a back-up roll, the single-layer nonwoven web comprising fibers and having a first side facing the heated roll, a second side facing the back-up roll and a thickness therebetween, the heated roll having a temperature above the melting point of at least some of the fibers; and
partially dry fusing the fibers on the first side of the single-layer nonwoven web to create a skin layer,
where the nonwoven web has a basis weight ranging from 20 gsm to 50 gsm, and
where the nonwoven web has a pressure drop index ranging from 40 to 100.

20. The method of claim 19, wherein the skin layer forms 5% to 20% of the thickness of the single-layer nonwoven web.

21. The method of claim 19, wherein the heated roll is a steel roll with a nickel-hardened steel surface.

22. The method of claim 19, wherein the back-up roll comprises a resilient surface made of rubber.

23. The method of claim 19, wherein the fibers of the single-layer nonwoven web are prebonded.

24. The method of claim 19, wherein the single-layer nonwoven web is passed through the nip at a rate of about 10 m/min to about 200 m/min.

25. The method of claim 19, wherein the single-layer nonwoven web is subjected to a nip pressure from 0N to 500N.

26. The method of claim 19, wherein the single-layer nonwoven web is embossed prior to partially dry fusing the fibers.
